(19) United States
(12) Patent Application Publication
(10) Pub. No.: US 2013/0012185 A1
(43) Pub. Date: Jan. 10, 2013

(54) SYSTEMS AND METHODS FOR REMOTE CONFIGURATION OR RE-CONFIGURATION OF SOFTWARE RESIDING ON A SIM CARD

(75) Inventors: Ofer Lavi, Tel Aviv (IL); Igal Zak, Tel Aviv (IL); Assi Rotbart, Tel Aviv (IL); Emanuel Peri, Givaataim (IL)

(73) Assignee: NTTM LIMITED, Nicosia (CY)

(21) Appl. No.: 13/583,871

(22) PCT Filed: Feb. 28, 2011
(86) PCT No.: PCT/IL11/00198

§ 371 Date: Sep. 10, 2012

Related U.S. Application Data
(60) Provisional application No. 61/311,457, filed on Mar. 8, 2010.

(51) Int. Cl. H04W 4/00; H04W 4/14

(52) U.S. Cl. 455/418

(57) ABSTRACT

A system for manipulating a communication device, the system comprising at least one re-configuration server for remotely re-configuring software installed on a SIM card residing on the communication device by sending a re-configuration to the communication device from a remote location.

### REFERENCE TO CO-PENDING APPLICATIONS

Priority is claimed from U.S. Patent Application No. 61/311,457 “Systems and methods for remote configuration or re-configuration of software residing on a sim card”, filed 8 Mar. 2010.

PCT Application No. PCT/IL2008/000932, entitled “A method for initiating a telephone connection between at least two parties”, filed 8 Jul. 2008, and published 15 Jan. 2009 as WO 2009/007956, is co-pending.

### FIELD OF THE INVENTION

The present invention relates generally to software configuration or re-configuration and more particularly to remote configuration or re-configuration of software.

### BACKGROUND OF THE INVENTION

Remotely re-configuring software installed on the body of a communication device i.e. not on the device's SIM card is known, e.g. in the following US patent documents:

US 2005/0141438 A1—METHOD AND SYSTEM FOR THE AUTOMATIC CONFIGURATION OF AN APPLIANCE IN A COMMUNICATIONS NETWORK; and

U.S. Pat. No. 6,286,038 B1—METHOD AND APPARATUS FOR REMOTELY CONFIGURING A NETWORK DEVICE.

It is also known in the art to erase first software and install second software, such as a newer version of the first software, in its place.

SIM Cards, JavaCards, and STK applications are known technologies whose specifications form part of the state of the art.

GSM is a standard for mobile phones. In GSM both signaling and speech channels are digital, and thus is considered a second generation mobile phone system.

The GSM standard provides a Subscriber Identity Module or SIM card which is a detachable smart card (Universal Integrated Circuit Card containing a SIM application) storing a user's subscription information and other data such as phone book. In 2G networks the UICC card is also termed a SIM card.

The equivalent of a SIM CARD in UMTS is a UICC, which runs a USIM application. A UICC with a CSIM application is used in CDMA-based devices.

The SIM Toolkit (STK) is an API between the Subscriber Identity Module (SIM) of a GSM mobile phone and an application, which allows telephone applications to be developed without modifying or installing software on the phone itself because the STK provides the user-interface for the new functionality. For example, the STK may provide an application with the ability to position a mobile unit. USIM Application Toolkit (USAT) is the equivalent of STK for 3G networks.

The disclosures of all publications and patent documents mentioned in the specification, and of the publications and patent documents cited therein directly or indirectly, are hereby incorporated by reference.

### SUMMARY OF THE INVENTION

Certain embodiments of the present invention seek to provide apparatus and methods for remotely configuring or re-configuring software installed on a SIM card. Throughout this application the term configuring shall imply either configuring or re-configuring. Similarly the term configuration shall imply either configuration or re-configuration.

One example of software which may be installed on a SIM card and subsequently re-configured remotely according to certain embodiments of the present invention, is described in co-pending PCT Application No. PCT/IL2008/000932, entitled “A method for initiating a telephone connection between at least two parties”, filed 8 Jul. 2008, and published 15 Jan. 2009 as WO 2009/007956.

Certain embodiments of the present invention seek to provide a remote re-configuration mechanism for STK-compatible (or other) applications residing on a SIM card. The re-configuration may be sent as a result of a request by said application, either after initial installation, when the SIM card is transferred to a new mobile handset, or the device is transferred to a new communication network (e.g. when roaming).

Certain embodiments of the present invention seek to provide an application which resides on a SIM card installed on a mobile device and which utilizes any API or programming toolkit which provides access to the SIM card's or mobile device's functionality such as but not limited to STK, and methods and systems for remote re-configuration of that application to use parameters which are appropriate for the mobile device on which the SIM card is installed or the communication network to which the mobile device is connected. Such re-configuration directives may include directions on how to best utilize the mobile device's display and/or may include directions on how to utilize the various STK (or other API) features to work best on the specific mobile device and/or network and/or may include directions on how to use the various GSM protocols (e.g. SMS, USSD) to work best on the specific mobile device and/or may include application specific parameters such as whether or not to allow the application to run on the specific device or on the specific communication network.

The remote re-configuration functionality may be an integral part of the application code or may be a standalone application which performs the communication with the server and stores the re-configuration information on the mobile device or the SIM card for use by another application.

The remote re-configuration may employ existing protocols and mechanisms and in particular may optionally use SMS, USSD, or data connection as the underlying transport protocol. The remote re-configuration may be either pull or push in that it may be initiated by either the client or the reconfiguration server respectively. The remote re-configuration may be either asynchronous (e.g. when using SMS) or synchronous (e.g. when using USSD).

The client may record the identifier of the device (IMEI for GSM/WCDMA/iDEN networks, MEID for CDMA networks, or ESN for AMPS/TDMA/CDMA networks) in its memory. The client may request remote re-configuration and include in the request the device identifier. The client may request remote re-configuration after its initial installation. This situation may be identified by the client detecting that it has no device identifier stored in memory or that it has not yet received any remote re-configuration commands. The client may request remote re-configuration when the SIM CARD on which it is installed is transferred to a new mobile handset. This situation may be identified by the client detecting that the current device identifier differs from the one stored in its memory.

The client may record the identifier of the communication network (MCC/MNC tuple for GSM/WCDMA/CDMA/iDEN/TETRA/UMTS networks) in its memory. The client may request remote re-configuration and include in the request the network identifier. The client may request remote re-configuration after its initial installation. This situation may be identified by the client detecting that it has no communication network identifier stored in memory or that it has not yet received any remote re-configuration commands. The client may request remote re-configuration when the mobile device in which the SIM card on which it is installed is transferred to a new communication network. This situation may be identified by the client detecting that the current communication network identifier differs from the one stored in its memory.

The reconfiguration server may send re-configuration commands to the client, based on the device identifier and/or the communication network identifier. The server may send the re-configuration as a result of a client request and/or as a result of an administrator's command. The reconfiguration server may request re-configuration receipt acknowledgement. The client typically acknowledges receipt of the re-configuration if so requested by the server. The client may utilize various fraud-protection, security and/or encryption mechanisms, such as a white-list of addresses from which, typically only from which, it is allowed to receive remote re-configuration commands. The white-list may identify re-configuration server addresses from which it is allowed to receive remote re-configurations, which addresses may for example comprise the server's MSISDN, short code, US SD service code, IP address, or other identifiers.

Certain embodiments of the present invention seek to provide a method whereby:

a. Software mounted in the SIM card of an individual communication device requests re-configuration at least each time the software discovers that the SIM CARD has moved from one communication device to another or each time the software discovers that the communication device on which the SIM CARD on which the software is installed is moved from one communication network to another;
b. A re-configuration server sends the re-configuration to the requesting communication device. The re-configuration server may be integral with the server of the communication network via which the communication devices, in which the SIM cards reside, communicate among themselves; and
c. A requesting communication device acknowledges receipt of the re-configuration to the re-configuration server.

The terms “remotely” and “over the air” are used herein generally interchangeably. The terms “client”, “application”, and “software” are used herein, in context, generally interchangeably. The term “body of the device” refers to the apparatus that remains once a SIM card is removed from a mobile communication device. The terms “handset” and “mobile communication device” are used herein generally interchangeably. It is appreciated that the term “software re-configuration” as used herein is not intended to include erasing first software and installing second software, such as a newer version of the first software, in its place. The term “profile download” is used herein to refer to a procedure that occurs at least each time the mobile communication device is turned on. The terms “server” and, “reconfiguration server” are used herein, in context, generally interchangeably.

There is thus provided, in accordance with at least one embodiment of the present invention a computer program product, comprising a computer usable medium or computer readable storage medium, typically tangible, having a computer readable program code embodied therein, the computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a computer readable storage medium.

Any suitable processor, display and input means may be used to process, display e.g. on a computer screen or other computer output device, store, and accept information such as information used by or generated by any of the methods and apparatus shown and described herein; the above processor, display and input means including computer programs, in accordance with some or all of the embodiments of the present invention. Any or all functionalities of the invention shown and described herein may be performed by a conventional personal computer processor, workstation or other programmable device or computer or electronic computing device, either general-purpose or specifically constructed, used for processing; a computer display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard, keypad or mouse for accepting. The term “process” as used above is intended to include any type of computation or manipulation or transformation of data represented as physical, e.g. electronic, phenomena which may occur or reside e.g. within registers and/or memories of a computer.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

### BRIEF DESCRIPTION OF THE DRAWINGS

Certain embodiments of the present invention are illustrated in the following drawings:

FIG. 1A is a table of terms and acronyms used herein.

FIG. 1B is a table of specifications forming part of the art and referred to herein by way of example.

FIG. 2A is a simplified functional block diagram of a system for manipulating a population of communication devices including at least one re-configuration server for remotely re-configuring software installed on SIM cards, the system being constructed and operative in accordance with certain embodiments of the present invention.

FIG. 2B is a simplified flow diagram of a process whereby the system of FIG. 2A is used to request and send a re-configuration to software installed on SIM cards, from a remote location.

FIG. 3 is a table of compilation directives supported by a system constructed and operative in accordance with certain embodiments of the present invention.

FIG. 4A is a table of an example of client requirements for certain applications of certain embodiments of the system of the present invention.

FIG. 4B is a table of an example of server requirements for certain applications of certain embodiments of the system of the present invention.

FIG. 5 is a diagram of an example structure overview of an RCC header in accordance with certain embodiments of the present invention.

### DETAILED DESCRIPTION OF CERTAIN EMBODIMENTS

A system for manipulating a communication device is now described, the system comprising at least one re-configuration server for remotely re-configuring software installed on a SIM card residing on the communication device by sending a re-configuration to the communication device from a remote location. The software may include any software having any functionality such as but not limited to any or all of the functionalities shown and described in co-pending published PCT application No. WO 2009/007956, such as but not limited to the functionality of adding a alpha-numeric dialing functionality including alphabetic dialing to a communication network which supports dialing from a first plurality of caller communication devices which can be dialed only numerically to a second plurality of telephone numbers. The functionality may for example involve installing software in each of the first plurality of communication devices, adding a resolver server to the network, and storing in the resolver server, a second plurality of call-names respectively corresponding to the second plurality of telephone numbers. The functionality may also include receiving an individual one of the second plurality of call-names dialed by an individual one of the first plurality of communication devices, sending the call-name to the resolver server via USSD or SMS; sending an individual one of the second plurality of telephone numbers corresponding to the individual one of the second plurality of call-names from the resolver server to the software installed on the individual one of the first plurality of communication devices, and using the software to initiate a telephone call from the individual one of the first plurality of communication devices to the individual one of the second plurality of telephone numbers.

The application shown and described herein provides users and software developers with a software functionality which typically needs to be supported on a wide range of mobile handsets. To do this, the application may utilize a specific combination of STK features, transport protocols, and parameters specific to each device. Certain embodiments of the present invention provide systems and methods for re-configuration in which the specific set of features for each device is stored on a suitable communication network and sent to the STK client either as a result of a client request or an administrator's command.

An STK client may request remote re-configuration at a suitable juncture such as but not limited to initial client installation, upon transfer of SIM CARD to a new mobile handset, and upon transfer of the mobile device in which the SIM CARD resides to a new communication network. A server may send re-configuration as a result of a suitable event such as but not limited to an STK client request or an Administrator command. The Server may request re-configuration delivery acknowledgement.

The application shown and described herein may be installed on a user's SIM card and utilize various features offered by the SIM Application Toolkit (S@T or STK). In order to allow per-device and/or per communication network re-configuration of the various STK and application features in use, a remote re-configuration mechanism is used e.g. as described herein.

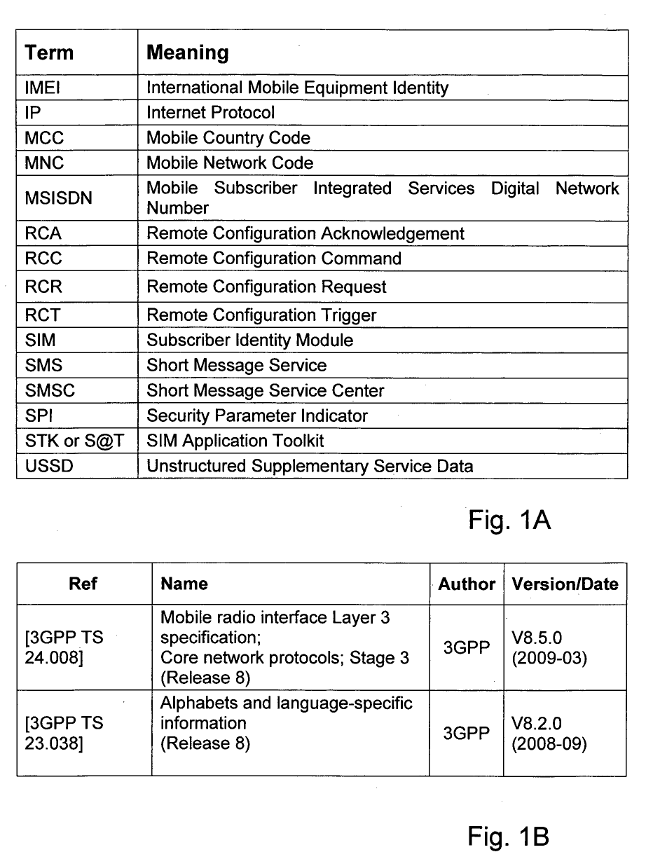

Terms and Acronyms used herein may be defined as in the art or with reference to the table of FIG. 1A. State of the art specifications referred to herein by way of example are listed in the table of FIG. 1B.

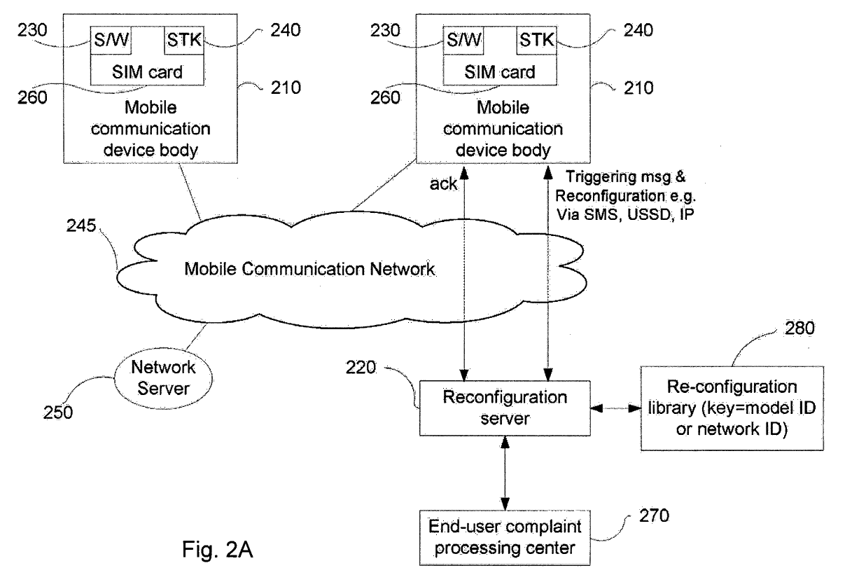

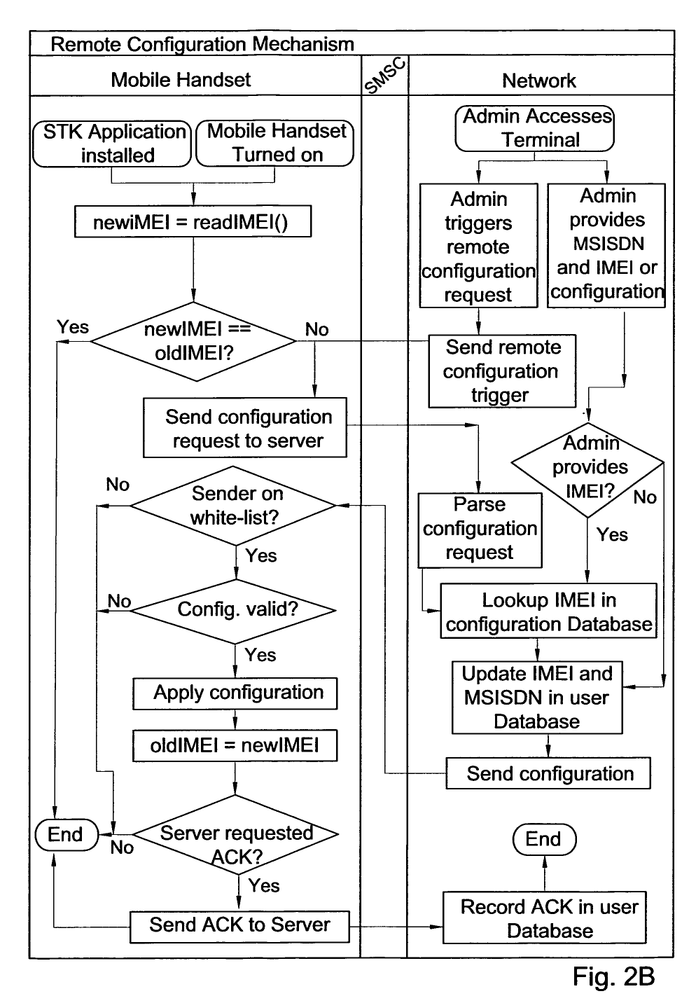

FIG. 2A is a simplified functional block diagram of a system for manipulating a population of communication devices 210, the system comprising at least one re-configuration server 220 for remotely re-configuring software 230 installed on a SIM card 240 residing on each of the communication devices 210, by sending a re-configuration to the communication device from a remote location. The communication devices typically include mobile devices communicating with one another via a conventional mobile communication device network 245 and an associated mobile communication device network server 250.

The re-configuration may be sent to a subset of the multiplicity of SIM cards 260 responsive to an administrator's command defining the subset and the re-configuration. For example, the software 230 may use a data connection to retrieve information, from the Internet, such as but not limited to currency conversion rates, weather forecasts, and news feed. For this purpose the software 230 may employ a pre-configured web site address from which this information is to be retrieved. If this website address changes an administrator would need to be able to re-configure some or all of the software instances installed on the SIM cards 260. The re-configuration may, for example, be sent via SMS, via USSD or via Internet protocol (IP). The software may include fraud-protection security and/or encryption mechanisms, such as a representation in memory of a white-list identifying at least one re-configuration server from which, and only from which, it is entitled to receive remote re-configurations.

The software 230 is typically operative to send to re-configuration server 220, at least each time the software discovers that the SIM card 260 has moved from one communication device 210 to another or that that mobile device 210 in which the SIM CARD 260 resides has moved from one communication network 245 to another, a request to receive a re-configuration of itself, the request including a new model identifier characterizing the device in which the SIM CARD currently resides and/or a new network identifier characterizing the communication network to which the device in which the SIM CARD currently resides is connected to. The model identifier typically comprises at least a portion of an identifier unique to the communication device vendor and/or model. If the identifier unique to the communication device vendor and/or model comprises an IMEI, the portion may comprise the TAC portion of the IMEI. The communication network identifier typically comprises a unique pair of mobile country code (MCC) and mobile network code (MNC) which uniquely identify the mobile communication network.

An STK unit 240 may be used to interface between software 230 and SIM card 260 and software 230 may record the model identifier of the device and/or the communication network identifier at each profile download. Optionally, each individual communication device acknowledges receipt of the re-configuration to the re-configuration server as shown.

Optionally, for at least one individual SIM card from among the multiplicity of SIM cards, a request is sent by the software installed on the individual SIM card to the re-configuration server responsive to a triggering message received by the individual SIM card. The triggering message may be sent to at least some of the multiplicity of SIM cards by the re-configuration server 220. Optionally, the re-configuration server sends the triggering message each time it is triggered to do so by an end-user complaint processing center 270.

Optionally, the re-configuration server interfaces with a library 280 of re-configurations and the re-configuration sent to said individual communication device is selected from the library based at least partly on the model identifier or the communication network identifier.

FIG. 2B is a simplified flow diagram of a process whereby a re-configuration is requested and sent. The process of FIG. 2B typically comprises some or all of the illustrated steps, suitably ordered e.g. as shown.

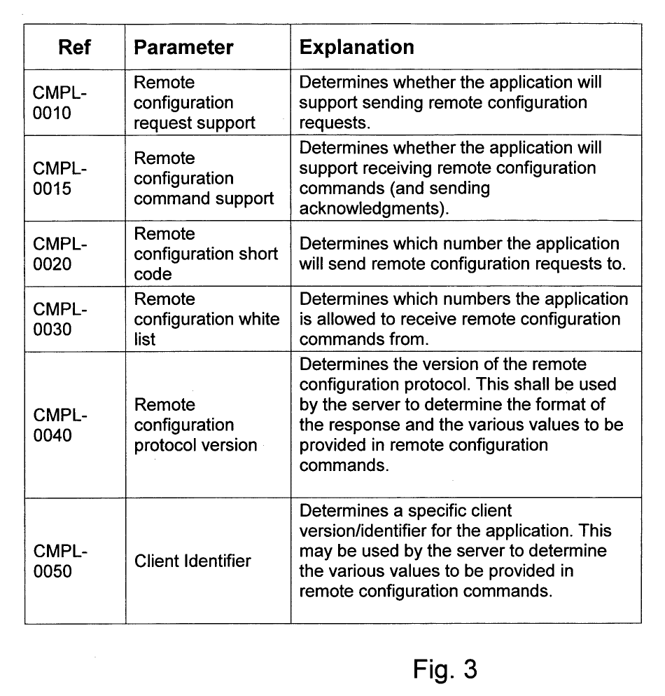

In order to support the remote re-configuration feature the application typically supports at least some or all of the additional compilation directives set out in FIG. 3. The remote re-configuration method of FIG. 2B typically allows re-configuration of application-specific parameters. Each parameter is typically provided with its type, an associated explanation, and a default value which may be used by the application e.g. for setting at compilation time.

Parameters may for example be of the following types, however it is appreciated that the various parameter categories listed below are provided merely by way of example:
Boolean—a true/false parameter
Byte—a value between 0x00 and 0xFF
Numeric—a positive number
Option—an enumeration of options
String—a sequence of characters
Phone Number—a dialing sequence
List<type>—a list of one of the other types

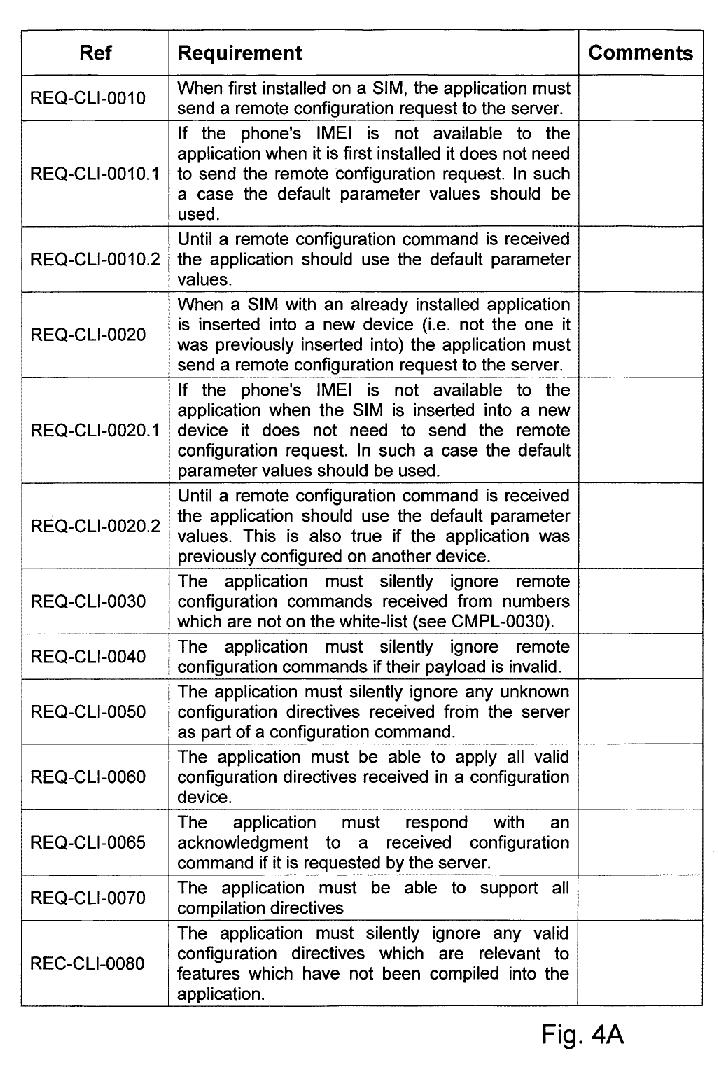

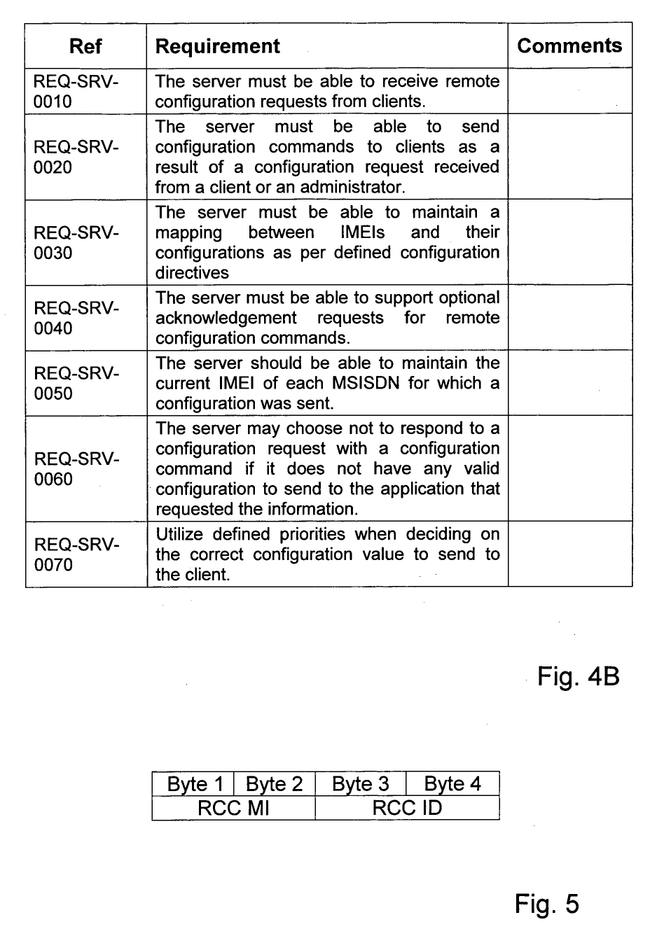

An example of client requirements for certain applications is set out in the table of FIG. 4A. An example of server requirements for certain applications is set out in the table of FIG. 4B.

The protocol may define some or all of the following operations:

a. Remote Re-configuration Request (RCR)

b. Remote Re-configuration Command (RCC)

c. Remote Re-configuration Acknowledgement (RCA).

d. Remote Re-configuration Trigger (RCT)

Certain embodiments of each of the above operations is now described in detail. It is appreciated however that the RCR as described herein is only one possible request that may be made by the client, the RCC as described herein is only one possible re-configuration command that may be sent by the server, the RCA as described herein is only one possible receipt that may be sent by the client to the server, and the RCT as described herein is only on possible trigger that may be sent by the server.
a. Remote Re-configuration Request (RCR) may be characterized, as per a particular protocol, as follows:
   Direction: Client->Server
   Carrier: SMS (single message)

The client may send the request to the number configured in CMPL-0020 using the phone's SMSC parameters. The structure of the request is as follows:

<Remote Configuration Protocol Version>*<Client
Identifier>*<IMEI>*<Operation>

### Where:

Remote Configuration Protocol Version—as defined in CMPL-0040
Client Identifier—as defined in CMPL-0050
IMEI—the phone's IMEI, as it is provided by the device to the STK application. The application should not perform any transformation or manipulation on the IMEI.
Operation-1
   The following is an example of an RCR message:

### 2*212*3A65520201105622*1

### Where:

2 indicates use of remote configuration protocol version#2
212 indicates a client identifier
3A65520201105622 indicates a BCD coded IMEI (356252010016522) of the device (Nokia 6120 Classic)
1 indicates operation#1 namely RCR
b. Remote Re-configuration Command (RCC) may be characterized, as per a particular protocol, as follows:
   Direction: Server->Client
   Carrier: Secure SMS (single message)
      The server may send the RCC as a silent SMS addressed to the CMN application.
      The server should indicate to the client whether it should acknowledge receipt of the command via the secure SMS headers (coded as part of the SPI)
      RCC Messages should be signed.
         Remote Re-configuration Commands may include a command header and command body, e.g. as follows:

### <RCC Header> <RCC Body>

Typically, no delimiters are used between any of the fields of the commands—fields are either fixed length (as defined by their type) or of variable length (and are then prefixed by a length byte). The order of fields is pre-set and thus no tags are included for the fields.

The header and body may make use of the data types (parameter types) defined above, which may be implemented as follows, respectively:
Boolean—boolean fields may be represented as a single byte. A value of 0x01 may be used to represent true and a value of 0x00 may be used to represent false.
Byte—byte fields may be represented with a single byte.
Numeric—numeric fields may be represented as two bytes (i.e. such fields may provide values between 0 and 65535).
Option—options may be represented as a single byte, 0x01 indicating the first option, 0x02 the second option, and so on. A value of 0x00 indicates that the option is not in use.
String—strings may be represented as a sequence of bytes. The first byte may indicate the length of the string (in bytes) and the rest of the bytes may comprise the string itself (no terminating byte is included). When an empty string is to be indicated the first byte may have the value 0x00. No other bytes may be provided in such a case.
Phone Number—phone numbers may be represented as a string with a predetermined internal structure. The first byte may indicate the length of the string in bytes (as a normal string would). The second byte may indicate the TON/NPI of the number and the rest of the bytes may comprise the number coded in extended BCD. In order to encode a number's TON and NPI a single byte may be used according to the description provided in [3GPP TS 24.008]. The TON field (bits 5-7) may have any of the values specified in Table 10.5.118/[3GPP TS 24.008]. The NPI field (bits 1-4) may have any of the values specified in Table 10.5.118/[3GPP TS 24.008]. In order to represent numbers using extended BCD encoding the structure defined in [3GPP TS 24.008] may be used.
List<Type>—a list of fields may be represented as a sequence of bytes. The first byte may include the number of items in the list. Following bytes represent each item in the list, encoded as the <Type> parameter of the list as described for each type above. When an empty list is to be indicated the first byte may have the value 0x00. No other bytes may be provided in such a case.
   The RCC Header defines parameters relating to the remote re-configuration protocol and does not refer specifically to the payload.

### Structure: <RCC MI> <RCC ID>

Typically, a RCC MI (Message Indicator) is provided. In order for the STK application to identify the incoming SMS as a remote re-configuration command the first two bytes of the SMS secure data for RCC messages may be 0xFF 0xF0. Typically, an RCC ID is provided, such as two bytes used to identify the current RCC in consequent RCAs. The server may choose the values used for this field.
Total Length: 4 bytes.
A typical structure overview of an RCC header is shown in the diagram of FIG. 5.

The RCC Body provides the client with configurable parameters e.g. as described above.
c. The Remote Re-configuration Acknowledgement (RCA) may be characterized, as per a particular protocol, as follows:
Direction: Client->Server
Carrier: SMS (single message)

Acknowledgement may be implemented using standard mechanisms already implemented by mobile devices. The application should provide the SIM card with an appropriate response code as specified below and if acknowledgement is requested in the SPI then the response code may be packed into the response SMS and sent automatically by the phone:

The application should send one of the following codes:
OK—if the received command was properly parsed and applied
NOK—if there is any problem with the received data or its application
d. Remote Re-configuration Trigger (RCT) may be characterized, as per a particular protocol, as follows:
   Direction: Server->Client
   Carrier: SMS (single message)
      The server shall send the RCT as a silent SMS addressed to the CMN application.
      RCT Messages should be signed.
         The structure of the Remote Configuration Triggers is as follows:

### <RCT MI> <RCT ID>

### Where:

RCT MI (Message Indicator)—In order for the STK application to identify the incoming SMS as a remote configuration trigger the first two bytes of the SMS secure data for RCT messages shall be 0xFF 0xF1.
RCT ID—two bytes used to identify the current RCT. The server may choose the values used for this field.

It is appreciated that the ability to remotely manage software on a SIM card, e.g. by re-configuration, has significant advantages, the software residing upon SIM cards typically relate solely to the communication device model that the SIM card is now residing in, rather than to all possible models, both due to the small storage capacity of the SIM card and due to the fast rate of emergence of new models.

It is appreciated that the ability to remotely install software on a SIM card, has significant advantages, e.g. relative to installation of the software on the body of the device. First, software can be installed over the air on the SIM card without user cooperation whereas software can be installed over the air on the body of the device only with user cooperation which both detracts from the user experience and requires a level of expertise which cannot be assumed for many end users. Also, there are far fewer SIM card versions than there are device versions, hence installation of software on the SIM card requires less versions of the software.

Typically, to initially install software on a SIM card, a secret key is obtained from the holder thereof which is normally the SIM card manufacturer or the communication network operator.

It is appreciated that references herein to STK are not intended to be limiting and may apply more generally to any application residing on a SIM card installed on a mobile device and which utilizes any API or programming toolkit which provide access to the SIM card's or mobile device's functionality.

It is appreciated that terminology such as “mandatory”, “required”, “need”, “shall” and “must” refer to implementation choices made within the context of a particular implementation or application described herewithin for clarity and are not intended to be limiting since in an alternative implantation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

Features of the present invention which are described in the context of separate embodiments may also be provided in combination in a single embodiment. Conversely, features of the invention, including method steps, which are described for brevity in the context of a single embodiment or in a certain order may be provided separately or in any suitable subcombination or in a different order. “e.g.” is used herein in the sense of a specific example which is not intended to be limiting. Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and steps therewithin, and functionalities described or illustrated as methods and steps therewithin can also be provided as systems and sub-units thereof. The scale used to illustrate various elements in the drawings is merely exemplary and/or appropriate for clarity of presentation and is not intended to be limiting.

1. A system for manipulating a communication device, the system comprising:
at least one re-configuration server for remotely re-configuring software installed on a SIM card residing on the communication device by sending a re-configuration to said communication device from a remote location.

2. A system according to claim 1 wherein a multiplicity of SIM cards reside respectively in a corresponding multiplicity of communication device bodies, and wherein said re-configuration is sent to a subset of said multiplicity of SIM cards responsive to an administrator's command defining said subset and said re-configuration.

3. A system according to claim 1 wherein said re-configuration is sent via SMS.

4. A system according to claim 1 wherein said re-configuration is sent via USSD.

5. A system according to claim 1 wherein said re-configuration is sent via Internet protocol (IP).

6. A system according to claim 1 wherein the software includes a representation in memory of a white-list identifying at least one re-configuration server from which and only from which it is entitled to receive remote re-configurations.

7. A system according to claim 1, wherein each communication device has a body having a model identifier and wherein the software is operative to send to a re-configuration server, at least each time the software discovers that the SIM card has moved from one communication device to another, a request to receive a re-configuration of itself, said request including at least a new model identifier characterizing the device in which the SIM card currently resides.

8. A system according to claim 7 wherein said re-configuration request is sent via SMS.

9. A system according to claim 7 wherein said re-configuration request is sent via USSD.

10. A system according to claim 7 wherein said re-configuration request is sent via Internet protocol (IP).

11. A system according to claim 7 wherein said model identifier comprises at least a portion of an identifier unique to said communication device vendor and/or model.

12. A system according to claim 11 wherein said identifier unique to said communication device comprises an IMEI.

13. A system according to claim 12 wherein said identifier comprises a portion of said IMEI.

14. A system according to claim 7 wherein STK is used to interface between said software and said SIM card and wherein said software records the model identifier of the device each time the profile download event is triggered.

15. A system according to claim 1 and wherein the individual communication device acknowledges receipt of the re-configuration to the re-configuration server.

16. A system according to claim 7 and wherein said software includes memory storing an indication of a model identifier of a device in which the SIM card has resided up till now and said software is operative to discover that the SIM card has moved from one communication device to another by requesting a current model identifier from the communication device body and by detecting that the current model identifier differs from said indication of a model identifier of a device in which the SIM card has resided up till now.

17. A system according to claim 7 wherein, for at least one individual SIM card from among said multiplicity of SIM cards, the request is sent by the software installed on said individual SIM card to the re-configuration server responsive to a triggering message received by said individual SIM card.

18. A system according to claim 17 wherein said triggering message is sent to at least some of said multiplicity of SIM cards by said re-configuration server.

19. A system according to claim 18 wherein said re-configuration server sends said triggering message each time it is triggered to do so by an end-user complaint processing center.

20. A system according to claim 7 wherein the re-configuration is generated based at least partly on said model identifier.

21. A system according to claim 7 and also comprising a library of re-configurations and wherein the re-configuration sent to said individual communication device is selected from said library based at least partly on said model identifier.

22. A system according to claim 7 wherein the software includes a representation in memory of a white-list identifying at least one re-configuration server from which and only from which it is entitled to receive remote re-configurations.

23. A method for manipulating at least one communication device, the method comprising:
remotely re-configuring software installed on a SIM card residing on the communication device by sending a re-configuration to said communication device from a remote location.

24. A method according to claim 23, wherein each communication device has a body having a unique model identifier and wherein the software is operative to send to a re-configuration server, at least each time the software discovers that the SIM card has moved from one communication device to another, a request to receive a re-configuration of itself, said request including at least a new model identifier characterizing the device in which the SIM card currently resides.

25. A method according to claim 24 and wherein said software includes memory storing an indication of a model identifier of a device in which the SIM card has resided up till now and said software is operative to discover that the SIM card has moved from one communication device to another by:
requesting a current model identifier from the communication device body; and
detecting that the current model identifier differs from said indication of a model identifier of a device in which the SIM card has resided up till now.

26. A computer program product, comprising a computer usable medium having a computer readable program code embodied therein, said computer readable program code adapted to be executed to implement any of the methods shown and described herein.

27. A system according to claim 1 wherein the software includes a representation in memory of encryption keys identifying at least one re-configuration server from which and only from which it is entitled to receive remote re-configurations, and used to secure communication with said re-configuration server.
